(19) United States
(12) Patent Application Publication
(10) Pub. No.: US 2015/0178452 A1
(43) Pub. Date: Jun. 25, 2015

(54) ORDERING A LIST OF CASES

(71) Applicant: KONINKLIJKE PHILIPS N.V., EINDHOVEN (NL)

(72) Inventors: Arvid Randal Nicolaas, Tilburg (NL); Gijs Geleijnse, Geldrop (NL); Ana Ivanovic, Eindhoven (NL); Roland Johannes Opfer, Hamberg (DE)

(73) Assignee: Koninklijke Philips N.V., Eindhoven (NL)

(21) Appl. No.: 14/415,202

(22) PCT Filed: Jul. 19, 2013
(86) PCT No.: PCT/IB2013/055953

§ 371 Date: Jan. 16, 2015

Related U.S. Application Data
(60) Provisional application No. 61/674,913, filed on Jul. 24, 2012.

(30) Foreign Application Priority Data
Jul. 24, 2012 (EP) 12177583.7

(51) Int. Cl. G06F 19/00; G06Q 50/22; G06Q 10/10

(52) U.S. Cl. CPC G06F 19/327; G06Q 10/1095; G06Q 50/22

(57) ABSTRACT

A system for ordering a list of cases to be discussed in a meeting comprises an urgency unit (1) for determining a level of urgency of a case based on case information (50) and a set of rules (51), wherein the level of urgency relates to an urgency to discuss the case. An order unit (2) is arranged for determining an order of a plurality of cases that are the subject of at least one meeting, based on the level of urgency. The set of rules (51) represents at least part of a procedure (52), and the urgency unit (1) comprises a procedure unit (3) for determining a position of the patient case in the procedure (52) based on the case information (50). The urgency unit (1) is arranged for determining the level of urgency in dependence on the position of the patient case in the procedure (52).

### FIELD OF THE INVENTION

The invention relates to ordering a list of cases to be discussed in a meeting.

### BACKGROUND OF THE INVENTION

Healthcare is becoming increasingly multidisciplinary. For example, the treatment approach of cancer patients may be decided in a multidisciplinary meeting.

A multidisciplinary meeting is a meeting in which clinicians from relevant disciplines may be present. This includes radiologists, pathologists, oncologists, surgeons, nurses, and any other discipline relevant for e.g. the type of cancer of the individual patient. These multidisciplinary meetings discuss patient cases to decide what the next treatment step should be for the discussed patient. A meeting typically consists of the discussion of multiple patient cases, while not all clinicians invited to the meeting are interested in all cases.

The scheduling of multidisciplinary meetings may be done as follows. Clinicians enroll patient cases to a meeting by sending messages, such as e-mails, to an administrator. The administrator compiles the cases in a list and sends the list of cases that are the subject of the meeting in a message to all involved clinicians. Furthermore, the administrator can use a standard meeting scheduling system to schedule the time slot of the meeting. For example, an existing calendaring tool or groupware, such as Microsoft Outlook, may provide functionality that helps a user to schedule meetings using availability information from various participants of a meeting.

### SUMMARY OF THE INVENTION

It would be advantageous to have an improved ordering of a list of cases to be discussed in a meeting. To better address this concern, a first aspect of the invention provides a system comprising

an urgency unit for determining a level of urgency of a case based on case information and a set of rules, wherein the level of urgency relates to an urgency to discuss the case; and

an order unit for determining an order of a plurality of cases that are the subject of at least one meeting, based on the level of urgency.

The order in which the cases are discussed in the meeting may be very important, because when the discussions are too long, there may be insufficient time to discuss all the patients that are eligible for discussion. Consequently, the patients that are last on the agenda may not be discussed at all. The discussion of these cases may be delayed to the next meeting, which may have an adverse effect on the prospect of these patients. In case the patient's discussion cannot wait until the next meeting, an additional meeting may have to be scheduled, which is not efficient. In view of these considerations, the order in which the cases are discussed in the meeting may have a clinical effect on the patients. By ordering the case based on a level of the urgency to discuss the patient case, this problem may be reduced. The urgency unit that determines the level of urgency for the case to be discussed, may combine the knowledge about the patient with more generic clinical rules to determine the level of urgency that the case be discussed in the multidisciplinary meeting. This enables the system to produce the ordered list automatically or semi-automatically.

The set of clinical rules may represent at least part of a procedure. The urgency unit may comprise a procedure unit for determining a position of the case in the procedure based on the case information. Moreover, the urgency unit may be arranged for determining the level of urgency in dependence on the position of the case in the procedure. The procedure may define a plurality of steps that the patient can go through. The urgency to discuss the patient may depend on the particular position in the procedure at which the patient is. An example of a clinical procedure is a clinical guideline. In a clinical guideline, typically a description of clinical action steps is combined with a description of a pre-condition, such as a patient condition, a care setting, or previous treatment information. Other examples include a best practice or a procedure derived from clinical evidence, such as recently gathered clinical evidence that has not yet made it into a clinical guideline.

The procedure may be annotated with an indication of the urgency to discuss the case at a particular position in the procedure. Such annotations may facilitate the urgency determiner to assess the urgency to discuss the case with more reliability and/or more efficiently.

The urgency unit may comprise a condition unit for detecting a medical condition of a patient in dependence on the case information. The medical condition of the patient may be an important factor in determining the urgency to discuss the patient's case, or for example to determine a position in a clinical procedure or guideline. The medical condition is preferably the current medical condition of the patient, however the condition unit may further be arranged for taking into account a medical history of the patient. Information relating to the medical history may be stored in the case information, including for example patient records and medical images of the patient.

The set of rules may comprise a rule associating the medical condition of the patient with an indication of the urgency to discuss the case. This is an example of how to determine the urgency to discuss the case based on the condition of the patient.

The set of rules may comprise a rule associating the medical condition of the patient with an indication of a potential urgency to perform a treatment that is capable of being decided in the multidisciplinary meeting. The urgency unit may be arranged for determining the urgency to discuss the case in the meeting in dependence on the indication of the potential urgency to perform the treatment. Sometimes the urgency to treat a patient is unclear, but a treatment recommendation of a multidisciplinary meeting could be that the patient should urgently undergo a particular treatment. The urgency unit may recognize this situation, and output a high level of urgency to discuss the case, even before it has been decided to perform an urgent treatment to the patient.

The system may comprise a selection unit for selecting the cases to be discussed in a multidisciplinary meeting, based on the level of urgency of the cases. This helps to know beforehand which patients are going to be discussed, and which patients are going to be scheduled for another meeting.

The case information may comprise at least part of a medical record of the patient. This medical record, such as an electronic health record, may comprise current and relevant information to assess the urgency to discuss the patient.

The urgency unit may comprise a complexity unit for determining a complexity of the patient case based on the case information. The urgency unit may be arranged for determining the level of urgency in dependence on the complexity. For example, a complex case could be scheduled at the beginning of the meeting, to make sure that there is sufficient time to discuss the case. Alternatively, a complex case may be scheduled at the end of the meeting, to ensure that sufficient time is available to make a decision in the more straightforward cases. This choice may further depend on the level of urgency to discuss the patients.

The system may comprise a participant unit for determining a group of participants needed for the discussion of the patient case, based on the case information and the set of clinical rules, and an availability unit for determining a time slot in which the group of participants is available for the discussion, based on availability information of individual participants, wherein the order unit is arranged for determining the order of the plurality of cases also in dependence on the time slot. This helps to order the cases in such a way that, when it is time to discuss a particular case, the necessary participants can be present at the meeting. Examples of participants are healthcare professionals, specialists, general practitioners, and nurses.

An advantage of this embodiment is that not all participants have to be present for the entire meeting; time slots may be determined so that a participant need only attend the time slots where cases are discussed for which the expertise of that participant is required.

The system may comprise an information unit for detecting whether information needed in the multidisciplinary meeting is missing from the case information. This may be used to schedule the case only when the necessary information is available for the discussion. For example, the urgency unit may be arranged for decreasing the urgency to discuss the patient case if information is missing from the case information. This avoids spending time on a patient during the meeting, when the necessary information is not present.

In another aspect, the invention provides a workstation comprising the system set forth.

In another aspect, the invention provides a method of ordering a list of cases to be discussed in a multidisciplinary meeting, comprising

determining a level of urgency of a patient case based on case information and a set of clinical rules, wherein the level of urgency relates to an urgency to discuss the patient case; and

determining an order of a plurality of cases that are the subject of at least one multidisciplinary meeting, based on the level of urgency.

In another aspect, the invention provides a computer program product comprising instructions for causing a processor system to perform the method set forth.

It will be appreciated by those skilled in the art that two or more of the above-mentioned embodiments, implementations, and/or aspects of the invention may be combined in any way deemed useful.

Modifications and variations of the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated hereinafter with reference to the drawings. In the drawings, similar items have been indicated by means of the same reference numerals. The drawings are diagrammatic.

FIG. 1 is a block diagram illustrating aspects of a system for ordering a list of cases to be discussed in a meeting.

FIG. 2 is a flowchart illustrating aspects of a method of ordering a list of cases to be discussed in a meeting.

### DETAILED DESCRIPTION OF EMBODIMENTS

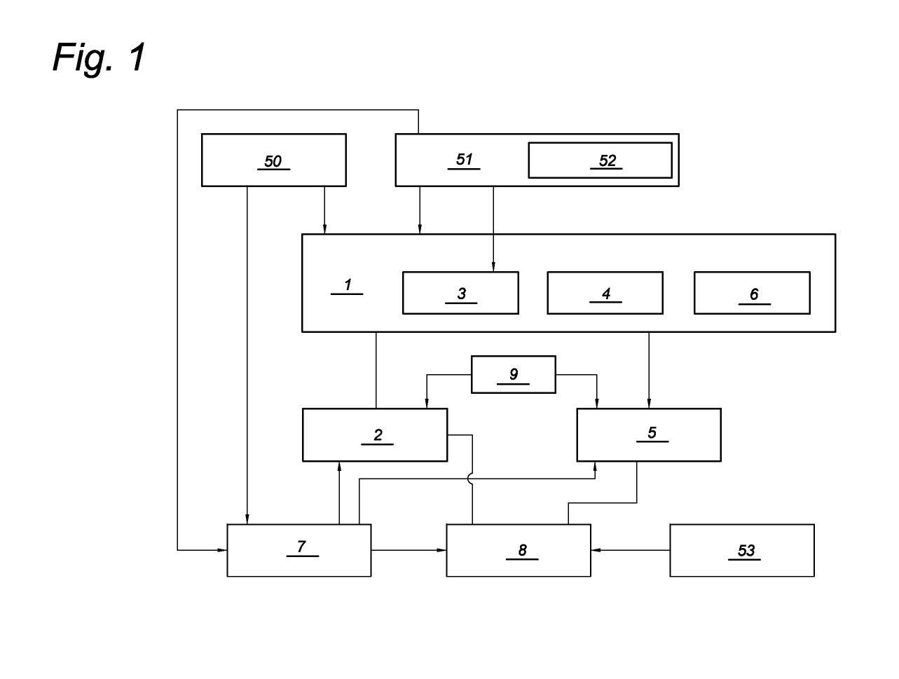

FIG. 1 illustrates a system for ordering a list of cases to be discussed in a meeting. The system may be computer-implemented. Alternatively, the system may be implemented using dedicated electronic circuitry. The system may be implemented on a server that provides computer services to client devices in an organization, such as a hospital or a federation of hospitals. For example, the system may be implemented as an extension to a health information system or a clinical decision support system. For example, the system is implemented in a client-server architecture or using a web-based user interface. Alternatively, the system may be implemented on a workstation. The system may comprise communication means, such as a network connection, to communicate with other devices and systems, such as database systems. For example, the system may be arranged for exchanging information with a hospital information system. Alternatively, the system is implemented as an extension or a modification of a hospital information system or a clinical decision support system.

The system may comprise an urgency unit 1 arranged for determining a level of urgency of a case, such as a patient case, based on case information 50 and a set of clinical rules 51. The case information 50 may be obtained from a database storing an electronic health record of the patient. The set of clinical rules 51 may be stored in a separate database containing domain knowledge. The case information 50 and the set of clinical rules 51 may be collected from different sources. It is not necessary that all case information is obtained from the same database, and also the clinical rules may be obtained from several different sources, including for example a clinical guideline, a collection of clinical evidence, and a collection of rules that are local to the hospital. The urgency unit may be arranged for matching information elements of the case information 50 with the rules in the set of clinical rules 51, to derive information from which the level of urgency may be determined. The level of urgency relates to an urgency to discuss the patient case. This urgency to discuss a patient case may be different from an urgency to perform a particular treatment. This will be discussed in more detail elsewhere in this description.

The system may comprise an order unit 2 arranged for determining an order of a plurality of cases that are the subject of at least one meeting. The ordering may result in an order in which the cases are scheduled to be discussed in the meeting. The ordering is based on the level of urgency to discuss the case in the meeting. For example, more urgent cases are scheduled closer to the beginning of the meeting, and less urgent cases are scheduled closer to the end of the meeting. However, the order unit 2 may be arranged for taking into account more parameters which may in addition influence the order in which cases are scheduled for discussion in the meeting.

The set of clinical rules 51 may represent at least part of a procedure 52, such as a clinical procedure. Such a clinical procedure 52 may represent clinical domain knowledge, and can have many different forms and contents. The urgency unit 1 may comprise a procedure unit 3 for determining a position of the patient case in the clinical procedure 52. This way, the procedure unit 3 determines which point in the procedure is relevant to the patient case. This can be determined by combining the case information 50 with the representation of the procedure. Such a representation of the procedure may comprise a set of clinical rules, for example, wherein a rule associates a set of criteria with a recommendation or next step, or directly with an urgency to discuss the patient case in a meeting. This enables the procedure unit 3 to derive information from the clinical procedure based on the case information 50. The urgency unit 1 may be arranged for determining the level of urgency in dependence on this information from the clinical procedure. For example, the clinical procedure may be annotated with an indication of the urgency to discuss the case at a particular position in the clinical procedure. Consequently, after determining the position in the procedure that is relevant for the patient case, the urgency unit 1 may determine whether such an annotation exists at that position in the procedure. If such an annotation exists, it may be used as one of the factors in determining the urgency to discuss the patient case.

The urgency unit 1 may comprise a condition unit 4 for detecting a medical condition of the patient in dependence on the case information 50. The medical condition may include a disease, a diagnosis, a symptom, or any other medical problem, that has been recorded in the case information. The set of clinical rules 51 may comprise a rule associating the medical condition of the patient with an indication of the urgency to discuss the patient case.

The set of clinical rules 51 may comprise a rule associating the medical condition of the patient with an indication of a potential urgency to perform a treatment that is capable of being decided in the meeting. The urgency unit 1 may be arranged for determining the urgency to discuss the case in the meeting further in dependence on the indication of the potential urgency to perform the treatment.

The system may comprise a selection unit 5 for selecting the cases to be discussed in a meeting. This selection may be based on the level of urgency of the cases. The selection unit 5 may be arranged for scheduling more cases than can be discussed at the meeting. However, as it is not entirely clear beforehand how long the discussion of each case will be, it is also not sure how many cases will be discussed. However, if the list of cases becomes unreasonably large, the less urgent cases may not be included in the meeting by the selection unit 5. These less urgent cases may be selected to be discussed in another meeting.

The case information 50 may comprise at least part of a medical record of the patient. Such a medical record, or a health record, may comprise comprehensive case information of a patient. However, the case information 50 may be obtained from more than one computer system or from a human operator input.

The urgency unit 1 may comprise a complexity unit 6 for determining a complexity of the patient case based on the case information 50, and wherein the urgency unit 1 is arranged for determining the level of urgency in dependence on the complexity. The complexity may be derived from the clinical condition or diagnosis of a patient (for example, when the patient has multiple diseases or metastases). Alternatively, the complexity may be derived from the size of the case information 50. Such a size may be counted in many ways, including the number of documents generated for the patient during the last months or in the whole patient history, or the size in bytes or words of the case information 50.

The system may comprise a participant unit 7 arranged for determining a group of participants needed for the discussion of the patient case. This may be determined by the participant unit 7, based on the case information 50 and the set of clinical rules 51. For example, the set of clinical rules 51 prescribes that, in view of a particular preliminary diagnosis, a prescribed group of healthcare professionals from different specialties should decide on a diagnosis and/or a treatment plan for the patient.

The system may comprise an availability unit 8 arranged for determining a time slot in which the group of participants is available for the discussion. To this end, the availability unit 8 may have access to availability information 53 of individual participants, for example via a shared calendar.

The order unit 2 may be arranged for determining the order of the plurality of cases also in dependence on the time slot, such that the patent case is scheduled in a time slot in which the necessary participants are available. Moreover, based on the urgency to discuss the patient, the patient may be scheduled near the beginning or near the end of this time slot.

The system may comprise an information unit 9 arranged for detecting whether information needed to discuss the patient case in the meeting is missing from the case information 50. The set of rules 51 may prescribe information items to be available in respect of the patient, before the discussion can take place or the decision taken. The information unit 9 detects whether these information items are present in the case information 50. The order unit 2 may be arranged for scheduling a case closer to the end of the meeting if such an information item is missing from the case information 50. This ordering may also be based on whether the information item is expected to arrive in the case information 50 during the meeting, as will be explained hereinafter. Alternatively, the selection unit 5 may be arranged for not selecting the patient case for the meeting, if such an information item is missing.

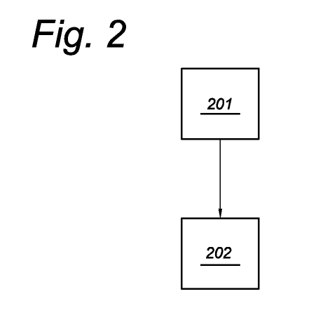

FIG. 2 illustrates a method of ordering a list of cases to be discussed in a meeting. The method may comprise a step 201 of determining a level of urgency of a patient case based on case information and a set of clinical rules, wherein the level of urgency relates to an urgency to discuss the patient case. The method may further comprise a step 202 of determining an order of a plurality of cases that are the subject of at least one meeting, based on the level of urgency. The method may be extended and/or modified based on the description of the functionality of the system.

Both the method and the system described herein may be implemented at least partly by means of a computer program product comprising instructions for causing a processor system to perform the functionality described herein.

The techniques disclosed herein may be implemented in an application that supports the workflow of a hospital associated with multidisciplinary oncology meetings. Such an application may provide tools to schedule the multidisciplinary meetings, and to arrange a list of patient cases to be discussed during the meeting. Furthermore, patient case details can be filled in before the meeting to make the meeting itself as efficient as possible.

In multidisciplinary meetings (for e.g. oncology), time is a scarce resource. Often, over 20 patients need to be discussed in exactly one hour, since clinicians have a very tight schedule. If not all the patients are discussed during the allowed time, the remaining patient cases will be postponed to the next meeting. This may be suboptimal, and may have adverse effects on the quality of care.

Other kinds of meetings may suffer from similar drawbacks.

The list of patient cases to be discussed in a multidisciplinary meeting is usually unordered. However, patient cases differ in urgency. If an urgent case is postponed because it is scheduled at the end of a meeting, it is more likely to have adverse effects than a non-urgent case. Most of the discussed cases may be “standard” cases, as the number of treatment options is limited, regardless of condition of the patient or the urgency of treatment. These standard cases can be discussed and decided in a relatively short amount of time. Some cases may be more complicated and need more discussion time. Standard cases could potentially be handled outside the meeting, needing only a confirmation from all involved clinicians. However, complex cases should be discussed during the meeting. Sometimes, a patient case may be scheduled on the condition that certain data becomes available (e.g. an imaging study). In an unordered case list, these cases may appear at the beginning of the meeting, while the chances are higher of the data being available at the end of the meeting. Consequently, it may be advantageous to take this into account when ordering the list of patients to be discussed. Furthermore, if the data does not become available, the case will be opened during the meeting only to find out that the case is not ready for discussion, causing loss of valuable time. Some clinicians may be only interested in one particular patient case of the cases discussed during the meeting. Without any scheduling support it may be hard for a clinician to know around which time he/she should be present at the meeting, resulting in valuable time being lost while waiting for the case to be discussed.

The techniques disclosed herein may be used for re-ordering the patient list and to provide real-time scheduling support to take these aspects into account. In this way, it may be used to reduce the risk of urgent or complex cases being postponed, increasing the quality of care. Furthermore, it maximizes the use of the valuable time of clinicians by improving the workflow.

A system for ordering a list of cases to be discussed in a meeting may comprise one or more of the following elements:

urgency assessment module: a module that calculates scores for the urgency (Urgency Score) of a patient case based on the available patient case data and (annotated) guideline recommendations. Patients with a higher urgency may be scheduled earlier in the meeting.

missing data detection module: determines whether important information is missing or pending for a patient (Completeness Indication). If pending information is found, the patient may be scheduled at or closer to the end of the meeting. Furthermore, a real-time indicator may be provided that shows an indication of the availability of the information. If the information does not become available, the patient is kept out of the discussion list or may be skipped. This can save time, since the case cannot be discussed successfully without this information.

patient case subscription module: clinicians can subscribe to one or more specific patient cases that may be discussed during meetings, while indicating their own availability. Based on this information, the system calculates Availability Boundaries, which are used by the patient case scheduler described next to schedule cases at fixed times, allowing clinicians to skip parts of the meeting without missing their own case or cases of interest.

patient case scheduler: this module takes the input of the previously described modules, and schedules the patient to optimize the workflow. Firstly, it ranks the patient cases according to a configurable scoring algorithm based on the Urgency Score, the Completeness Indication. The scheduler re-orders the patient cases scheduled for a meeting according to the resulting ranking. Furthermore, it uses the Availability Boundaries to schedule certain patient cases within the boundaries, such that clinicians interested only in one case need to be present for a minimum amount of time.

The Urgency Score of a patient case may be determined using any one or more of the following approaches:

1. Using domain-specific rules on patient data. For example: a cancer patient with metastases may be more urgent than one without metastases. By specifying a number of those rules combining patient conditions with urgency scores, and totaling the scores, a level of urgency may be assessed. The patient case scheduler uses this score to determine the patient case order in the list.

a. As an example consider two rules: First rule: “patient has metastatis Urgency Score 1”. Second rule: “the tumor is recurring Urgency Score 1”. If both rules are true for a patient case, the system may calculate the sum (or another combination) of all applicable Urgency Scores, in this example the total Urgency Score would be 2.

2. Using metadata in a guideline (or in any kind of procedure). In this case, guideline authors may add urgency annotations (or metadata) to the recommendations in the guideline (or to the steps of the procedure). When a guideline engine determines the recommendation for a patient, it can use the attached annotations in its assessment of the urgency. If the guideline engine does not produce a recommendation, this can also be an indication that the patient is a “complex” case that needs more discussion.

As an example, consider two guideline recommendations, g1 and g2, with associated urgency scores u1 and u2, respectively. This means that a patient case having recommendation g1 has an urgency score u1, and a patient case with recommendation g2 has an urgency score u2.

3. By assessing the patient's electronic health record (EHR). Information elements in the health record may be associated with a particular Urgency Score. Moreover, from the electronic health record, it may be determined how complex the case is. This complexity may influence the Urgency Score. For example, if it is determined that a case is a complex case (for example based on the amount of information in the electronic health record), this fact may lead to a higher Urgency Score. The amount of information can for example be measured by counting the number of characters in text documents in the patient's EHR, or by counting the total number of bytes occupied by the EHR.
4. By enabling a user to indicate an Urgency Score using a predefined scale.

The urgency assessment module may be arranged for receiving and processing the following kinds of input data.

Patient Case Information

a. Patient ID
i. Decision to be taken at the meeting

b. Decision type: diagnosis/treatment recommendation

c. Clinical data
i. Diagnosis (primary, secondary)
ii. Disease stage classification (for example, a numerical value)
   1. For example, the TNM Classification of Malignant Tumours (TNM) is a cancer staging system that describes the extent of cancer in a patient's body. Herein, T describes the size of the tumor and whether it has invaded nearby tissue, N describes regional lymph nodes that are involved, and M describes distant metastasis (spread of cancer from one body part to another).
   2. For example, symptom assessment for cardiology (oedema score, breathlessness score).
iii. Order examination status: describes the status of information that was ordered for this patient, such as an image acquisition or a lab study. Possible statuses include: none, ordered, received.
iv. Age of the patient
v. Time elapsed since the onset of the disease/recurrence of the disease
vi. Time elapsed since first diagnosis
vii. Number of readmissions of the patient.

Clinical recommendations (from a set of clinical rules, such as a description or representation of a clinical procedure or a clinical guideline)

d. Adopted clinical guidelines, optionally including Class & Evidence.

The urgency assessment module may be arranged for combining or using one or more of the above-mentioned approaches and processing one or more of the above-mentioned input data, to determine the level of urgency to discuss a case. This may involve computing and combining several different kinds of Urgency Score.

Hereinafter, an algorithm is described that can be used to assess an Urgency Score from a typical guideline stating the class and the evidence level of the recommendations.

The algorithm may assess the disease stage and retrieve appropriate recommendations (which may include a class and an evidence level) from at least one applicable clinical guideline. The process of determining an appropriate recommendation may be performed by a clinical decision support system, known in the art per se. For the recommendations the algorithm may calculate an urgency score, for example:

Urgency Score=stage*(1/(class*evidence)).

In this formula, higher stage diseases (which are more complex) get a higher score, and high recommendations with strong evidence get a lower score since it is evident to clinicians which decision to take. For each decision there can be multiple recommendations in the guidelines, therefore the score is indexed.

The missing data module may be arranged for determining whether important information for making a decision is missing or pending (Completeness Indication). Sometimes an examination of a patient is scheduled or performed shortly before the multidisciplinary meeting. For any information object that is needed during the meeting, the status may be any one of:

available. In such a case, Completeness Indication=Available.
unavailable, but may become available during the time span of the meeting. In such a case, Completeness Indication=Pending.

unavailable and not expected to become available during the meeting. In such a case, Completeness Indication=Incomplete.

These statuses may be determined based on the workflow of the hospital and the expected throughput of the specific information object.

In case the results may become available during the meeting, the chances of availability are highest near the end of the meeting. If the data does not become available in time, the case needs to be postponed to the next meeting. The missing information module detects the missing data and advises the scheduler to put this case at the end of the meeting.

In a real-time setting, the module can also provide an indication to a participant of the meeting of whether the data is available. This signal can be used during the meeting to decide to skip this case if data is not available. If data becomes available during the meeting, the signal changes and the patient case can be discussed. Alternatively, the patient is put on a “reserve” list, and may be scheduled in real-time, during the meeting, when the data becomes available. Alternatively, the system can give an alert when the data becomes available.

The patient case subscription module may enable clinicians to “subscribe” to certain patient cases to be discussed in the multidisciplinary meeting. Together with the subscription, the clinician can indicate his/her availability. The module determines a suitable time for the case discussion fitting the clinician's availability, and taking into account other “reservations” and the average time to discuss a case. During the meeting, the scheduler ensures that, after the committed timeslot starts, the committed case is the next to be discussed. Alternatively, the module may provide an alerting mechanism, warning the clinician a certain amount of time before the case will likely be discussed.

The input-output data items of the patient case subscription module can be classified as follows:

Input parameters:

### 1. List of Patient IDs

2. Meeting timeslot

### 3. Participant

a. Doctor ID

b. Agenda/Availability

c. Subscribed Patient IDs

### Output:

4. Time constraints for attending the meeting

A participant, such as a healthcare professional, specifies the Patient IDs of his interest for the multidisciplinary meeting. Based on his availability (according to his calendar), the algorithm calculates the time constraints during which the participant can attend the case discussion.

The patient case scheduler may take a number of inputs from the previously described modules, and perform static and/or dynamic re-ordering to the list of patient cases. The static scheduler may apply a configurable rule set and weighting to the outcomes of the urgency assessment module. The dynamic scheduler may make real-time judgments of when a case should be discussed using the input from the missing data detection and patient case subscription modules.

The scheduler may perform any one or more of the following tasks:

Rank the cases according to the level of urgency to discuss a case (from urgent to less urgent).

Rank the cases based on several Urgency Scores of the same case, wherein the different Urgency Scores represent different kinds of urgency or different reasons for the urgency to discuss the patient.

Removes cases with a Completeness Indicator set to Incomplete.

Move cases with a Completeness Indicator equal to Pending towards the end of the list, or to a separate “pending” list.

Move cases to which absent users have subscribed to the pending list, to be scheduled at the defined time slots.

During the meeting, when the case being discussed passes the start of a time constraint of a case in the pending list, that case in the pending list may be scheduled as the next case to be discussed.

During the meeting, if the Completeness Indicator of a pending case changes because of data becoming available, the case may be entered into the list of cases to be discussed, taking into account the urgency; or the order of cases to be discussed may be changed based on the level of urgency, moving the case that now has Completeness Indicator equal to Complete towards the top of the list.

Alternatively, instead of automatically re-ordering the list, the system only gives suggestions for re-ordering the list or which case to discuss next.

The “discussion urgency score” may be determined, among other things, by the complexity of the case. Per expert, circumstances in the patient condition may be modeled that reflect the need of the involvement of that expert. The higher the accumulated sum of the necessary involvement of a number of different experts, the higher the urgency to discuss the patient may be.

In a case in which the available set of rules 51 or clinical procedure 52 or clinical guidelines do not define a clear treatment or urgency to treat a patient, they may still provide sufficient information to determine an urgency to discuss the case.

The following types of expert may be participants in a meeting, such as a multi-disciplinary meeting. A Consulting Cardiologist may be responsible for the treatment of hospitalized cardiology patients. An Interventional Cardiologist may act as a consultant for, and expert on catheterization treatments and diagnostics. A Physician Assistant may be responsible for the daily management of a selection of the hospitalized cardiology patients. A Nurse may be responsible for daily care of the patient. A Discharge Planner may be responsible for discharging the patient and planning the follow-up care. A Pharmacist may have a consulting role on pharmaceutical treatment and drug interactions. The system may schedule meetings to discuss patient cases among members of this multi-disciplinary team.

Hereinafter, an example of algorithm for determining the urgency to discuss a patient case will be described in more detail. The specifics described herein are merely examples. The input parameters of the exemplary algorithm may include one or more of the following.

Set RPD of pairs of necessary patient data and their corresponding weights according to importance (rpd1, w1) . . . (rpdn, wn). The sum of w1 to wn should be 1.

Average patient case discussion time ADT

Meeting details:
Time constraints (tbegin, tend)

Set of patients PAT (pat1 . . . patn)
For each patient:
Set of physicians/roles expected to attend PHYS (rr1 . . . rrn)
Diagnosis/imaging data and patient history PD (pd1 . . . pdn)
Set of guideline recommendations (rec1 . . . recn)

Set of domain specific urgency rules (RUL) on patient data and guideline recommendations nil: {PD,rec} w. Each rule can be evaluated results in a weight value indicating the urgency for discussion.

For each physician/role:
Meeting Availability (ptbegin, ptend)

The algorithm may comprise the following modules.

Missing Data Module: calculates in how far the patient data is complete for discussion. If there are missing important items, the patient cannot be discussed and time can be better allocated for other patients. The algorithm selects from the RPD set those items (rpd) that match with items present in the PD set (pd). Of these selected items, the algorithm sums the weight values (w). The result is a number between 0 and 1 that indicates the completeness for this patient.

Urgency Module: Evaluates the rules in RUL based on the patient data PD and the guideline recommendations rec. For each rul in RUL that is true, the corresponding weight w is added to a total URG. The higher the URG value, the more urgent the patient case is for discussion.

Subscribe Module: Allows physicians to indicate that they need to be present when a specific patient case in PAT is discussed. When a physician indicates her desired presence, she is added to the patient's PHYS set, together with her availability.

Schedule Module: optimizes the schedule for the meeting according to the inputs from the other modules.

The first step of the algorithm is to re-order the patients according to the results of the Missing Data Module (mdm) and the Urgency Module (um). An example of a formula it can use is to multiply both values, so urgency score us=mdm*um. The list of patients PAT is then sorted from high to low based on this result. This ensures that the more urgent cases are discussed in the beginning of the meeting, but only if there is enough data. Each patient is assigned a timeslot according to the average discussion time ADT.

The next step of the algorithm is to check for each patient in PAT whether all of the physicians in PHYS are available at the given timeslot. If it turns out that this is not the case, the algorithm executes an algorithm to find a suitable timeslot if possible, and re-orders the list according to the result.

It may turn out that there is no schedule that satisfies all constraints. In this case, the algorithm takes out the cases that cannot be scheduled and returns these to be either rescheduled or to take action to find replacement roles.

Hereinafter, an example in the domain of oncology will be described. There is a multidisciplinary Lung Cancer meeting of 30 minutes containing from 9.00 until 9.30 for 3 patients that need to be discussed. The average discussion time ADT is 10 minutes per patient. The necessary data items needed for a fruitful discussion in the meeting are:

TNM stage w=0.5

Lung Cancer type w=0.25

Imaging studies w=0.25.

The 3 patient cases PAT are as follows:

Patient 1: TNM stage=T2N0M0, Lung Cancer Type=Non-Small Cell, Imaging studies done. Guideline recommendations: Surgery.

Patient 2: TNM stage=unknown, Lung Cancer Type=Unknown, Imaging studies done. Guideline recommendations: none.

Patient 3: TNM stage=T3N1M1, Lung Cancer Type=Non-Small Cell, Imaging studies pending. Guideline recommendations: Chemotherapy.

The Urgency rules are as follows:

IF TNM stage.T>1 THEN increment w with 1

IF TNM stage.N>0 THEN increment w with 1

IF TNM stage.M>0 THEN increment w with 1

IF Guideline Recommendation=Chemotherapy THEN increment w with 1

The roles of necessary participants PHYS per patient are: Radiologist, Pathologist. There are 2 radiologists and 1 pathologist. Radiologist 1 needs to be present for cases 2 and 3 and is available during the whole meeting. Radiologist 2 needs to be present for Patient 1 and is available from 9.15.

The Missing Data Module results in the following completeness scores:

Patient 1: 0.5+0.25+0.25=1.0

Patient 2: 0.0+0.0+0.25=0.25

Patient 3: 0.5+0.25+0.0=0.75

The Urgency Module results in the following scores:

Patient 1: 0+0+0+0=1

Patient 2: 0+0+0+0=0

Patient 3: 1+1+1+1=4

The Schedule Module calculates the following priorities based on the outputs of the other modules:

Patient 1: 1.0*1=1.0

Patient 2: 0.25*0=0.0

Patient 3: 0.75*4=3.0

The module reorders the patients according to these priorities, resulting in the order with timeslots:

Patient 3: 9.00 to 9.10

Patient 1: 9.10 to 9.20

Patient 2: 9.20 to 9.30

The module checks this schedule with the physician availability and discovers that Radiologist 2 is not present when Patient 1 is discussed. It therefore re-orders the list as follows:

Patient 3: 9.00 to 9.10

Patient 2: 9.10 to 9.20

Patient 1: 9.20 to 9.30

This is the optimal schedule for the meeting.

The techniques disclosed herein may be used to plan multidisciplinary meetings for oncology. However, other care cycles, such as cardiology, also increasingly use the instrument of multidisciplinary meetings. The techniques described herein can also be used in other domains where efficiency is important and time is valuable, including but not limited to medical domains.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention.

An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for ordering a list of cases to be discussed in a meeting, comprising
an urgency unit for determining a level of urgency of a case based on case information and a set of rules, wherein the level of urgency relates to an urgency to discuss the case; and
an order unit for determining an order of a plurality of cases that are the subject of at least one meeting, based on the level of urgency.

2. The system according to claim 1, wherein the set of rules represents at least part of a procedure, and wherein the urgency unit comprises a procedure unit for determining a position of the case in the procedure based on the case information and wherein the urgency unit is arranged for determining the level of urgency in dependence on the position of the case in the procedure.

3. The system according to claim 2, wherein the procedure is annotated with an indication of the urgency to discuss the case at a particular position in the procedure.

4. The system according to claim 1, wherein the urgency unit comprises a condition unit for detecting a medical condition of a patient in dependence on the case information.

5. The system according to claim 4, wherein the set of rules comprises a rule associating the medical condition of the patient with an indication of the urgency to discuss the case.

6. The system according to claim 4, wherein the set of rules comprises a rule associating the medical condition of the patient with an indication of a potential urgency to perform a treatment that is capable of being decided in the meeting, and wherein the urgency unit is arranged for determining the urgency to discuss the case in the meeting further in dependence on the indication of the potential urgency to perform the treatment.

7. The system according to claim 1, comprising a selection unit for selecting the cases to be discussed in a meeting, based on the level of urgency of the cases.

8. The system according to claim 1, wherein the case information comprises at least part of a medical record of the patient.

9. The system according to claim 1, wherein the urgency unit comprises a complexity unit for determining a complexity of the patient case based on the case information, and wherein the urgency unit is arranged for determining the level of urgency in dependence on the complexity.

10. The system according to claim 1, comprising
a participant unit for determining a group of participants needed for the discussion of the patient case, based on the case information and the set of clinical rules; and
an availability unit for determining a time slot in which the group of participants is available for the discussion, based on availability information of individual participants,
wherein the order unit arranged for determining the order of the plurality of cases also in dependence on the time slot.

11. The system according to claim 1, further comprising an information unit for detecting whether information needed to discuss the patient case in the meeting is missing from the case information.

12. A workstation comprising the system according to claim 1.

13. A method of ordering a list of cases to be discussed in a meeting, comprising
determining a level of urgency of a case based on case information and a set of rules, wherein the level of urgency relates to an urgency to discuss the case; and
determining an order of a plurality of cases that are the subject of at least one meeting, based on the level of urgency.

14. A computer program product comprising instructions for causing a processor system to perform the method according to claim 13.
